(19) United States
(12) Patent Application Publication
(10) Pub. No.: US 2025/0300206 A1
(43) Pub. Date: Sep. 25, 2025

(54) FUEL CELL SYSTEM

(71) Applicant: Honda Motor Co., Ltd., Tokyo (JP)

(72) Inventors: Kazusa Ishikawa, Saitama (JP); Sena Takekoshi, Saitama (JP)

(21) Appl. No.: 19/053,841

(22) Filed: Feb. 14, 2025

(30) Foreign Application Priority Data
Mar. 19, 2024 (JP) 2024-044025

(51) Int. Cl. H01M 8/04746; H01M 8/04082; H01M 8/0444; H01M 8/04537

(52) U.S. Cl. CPC H01M 8/04761; H01M 8/04201; H01M 8/04462; H01M 8/04604

(57) ABSTRACT

Fuel cell system includes: fuel cell stack configured to generate power by anode/cathode gas in anode/cathode flow path: anode/cathode supply flow path supplying anode/cathode gas to anode/cathode flow path; anode/cathode discharge flow path discharging anode/cathode off-gas from anode/cathode flow path; combining portion combining anode/cathode off-gas flowing through anode/cathode discharge flow path; discharge pipe guiding combined gas combined in combining portion to outside; anode discharge valve configured to control flow of anode off-gas toward combining portion; and control unit configured to control opening and closing of anode discharge valve. Control unit: acquires hydrogen concentration of combined gas; and controls opening and closing of anode discharge valve to repeat opening/closing operation of opening for opening time based on hydrogen concentration and closing in case where power generation amount of fuel cell stack is equal to or less than power generation threshold.

### CROSS-REFERENCE TO RELATED APPLICATION

This application is based upon and claims the benefit of priority from Japanese Patent Application No. 2024-044025 filed on Mar. 19, 2024, the content of which is incorporated herein by reference.

### BACKGROUND OF THE INVENTION

### Field of the Invention

The present invention relates to a fuel cell system.

### Description of the Related Art

In a fuel cell system, when an anode off-gas containing hydrogen, nitrogen, moisture, and the like is discharged to the outside of the fuel cell system (in the atmosphere), air (nitrogen, oxygen, or the like) sucked from the outside is used to dilute a gas to be discharged. Therefore, in a case where a large amount of air is required for dilution, power consumption of a compressor or the like that sends air increases. In this regard, a system that achieves both improvement in fuel efficiency and maintenance of hydrogen concentration has been proposed.

For example, in the technique described in JP 2023-132388 A, even in a case where a target power generation amount is smaller than a predetermined threshold, the amount of air for dilution may be increased (in other words, the rotation amount of the compressor or the like is increased) in order to suppress the hydrogen concentration of the gas to be discharged to a predetermined concentration.

### SUMMARY OF THE INVENTION

An aspect of the present invention is a fuel cell system, including: a fuel cell stack configured to generate power by anode gas in an anode flow path and cathode gas in a cathode flow path: an anode supply flow path supplying the anode gas to the anode flow path; a cathode supply flow path supplying the cathode gas to the cathode flow path; an anode discharge flow path discharging anode off-gas from the anode flow path; a cathode discharge flow path discharging cathode off-gas from the cathode flow path; a combining portion combining the anode off-gas flowing through the anode discharge flow path and the cathode off-gas flowing through the cathode discharge flow path; a discharge pipe guiding combined gas combined in the combining portion to outside; an anode discharge valve configured to control flow of the anode off-gas toward the combining portion; and a control unit configured to control opening and closing of the anode discharge valve. The control unit: acquires a hydrogen concentration of the combined gas; and controls opening and closing of the anode discharge valve to repeat an opening/closing operation of opening for an opening time based on the hydrogen concentration and closing in a case where a power generation amount of the fuel cell stack is equal to or less than a power generation threshold.

### BRIEF DESCRIPTION OF THE DRAWINGS

The objects, features, and advantages of the present invention will become clearer from the following description of embodiments in relation to the attached drawings, in which:

FIG. 1 is a schematic configuration diagram of a fuel cell system according to an embodiment of the present invention;

FIG. 2 is a schematic diagram illustrating a relationship between opening/closing timing of a valve and a hydrogen concentration of combined gas; and

FIG. 3 is a flowchart illustrating an example of valve control processing executed by a control unit based on a predetermined program.

### DETAILED DESCRIPTION OF THE INVENTION

An embodiment of the invention will be described below with reference to the drawings.

### <Configuration of Fuel Cell System>

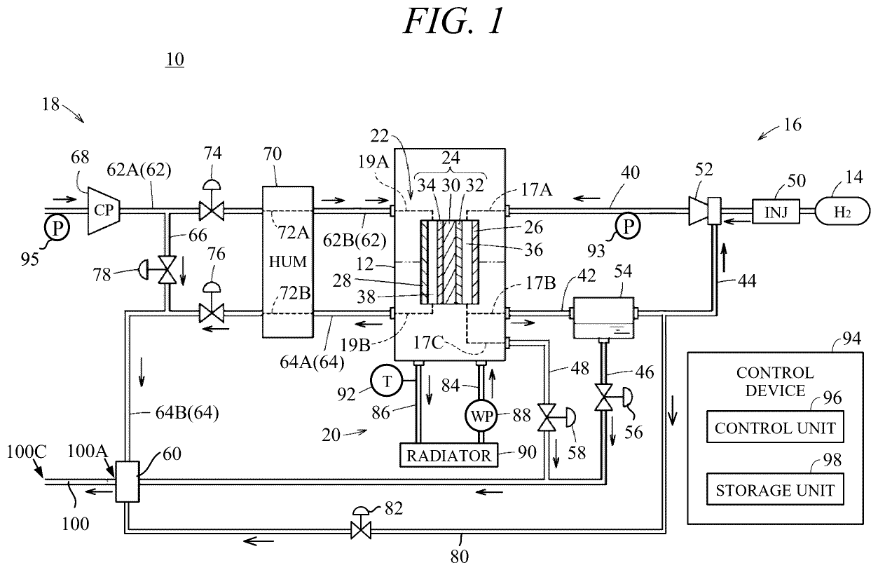

FIG. 1 is a schematic configuration diagram of a fuel cell system 10 according to an embodiment of the present invention. The fuel cell system 10 is mounted on a vehicle (fuel cell vehicle). Apart from this, the fuel cell system 10 can also be mounted on, for example, a ship, an aircraft, a robot, and the like. The fuel cell system 10 includes a fuel cell stack 12, a hydrogen tank 14, an anode system 16, a cathode system 18, and a cooling system 20. In addition, the fuel cell system 10 includes a control device 94. An output (electric power) of the fuel cell stack 12 is supplied to a load (not illustrated) such as a motor.

The fuel cell stack 12 includes a plurality of power generation cells 22 stacked in one direction. Each power generation cell 22 has an electrolyte membrane/electrode structure 24 (also simply referred to as an electrode structure 24) and a pair of separators 26 and 28. The pair of separators 26 and 28 sandwiches the electrode structure 24.

The electrode structure 24 includes a solid polymer electrolyte membrane 30 (also simply referred to as an electrolyte membrane 30), an anode electrode 32, and a cathode electrode 34. The electrolyte membrane 30 is, for example, a thin film of perfluorosulfonic acid containing moisture. The anode electrode 32 and the cathode electrode 34 sandwich the electrolyte membrane 30. The anode electrode 32 and the cathode electrode 34 each have a gas diffusion layer made of carbon paper or the like. Porous carbon particles are uniformly applied to the surface of the gas diffusion layer to form an electrode catalyst layer. A platinum alloy is supported on the surface of the porous carbon particles. The electrode catalyst layer is formed on each of both surfaces of the electrolyte membrane 30.

An anode flow path 36 is formed on a surface facing the electrode structure 24 among the surfaces of the separator 26. The anode flow path 36 is connected to an anode supply flow path 40 via an anode inlet 17A. The anode flow path 36 is connected to an anode discharge flow path 42 via a first anode outlet 17B. In addition, the anode flow path 36 is connected to a second drain flow path 48 via a second anode outlet 17C. The second anode outlet 17C is located lower than the first anode outlet 17B. A cathode flow path 38 is formed on a surface facing the electrode structure 24 among the surfaces of the separator 28. The cathode flow path 38 is connected to a cathode supply flow path 62 via a cathode inlet 19A. The cathode flow path 38 is connected to a cathode discharge flow path 64 via a cathode outlet 19B.

An anode gas (hydrogen) is supplied to the anode electrode 32. In the anode electrode 32, hydrogen ions and electrons are generated from hydrogen molecules by an electrode reaction by a catalyst. The hydrogen ions permeate the electrolyte membrane 30 and move to the cathode electrode 34. The electrons move in the order of a negative electrode terminal (not illustrated) of the fuel cell stack 12, a load such as a motor, a positive electrode terminal (not illustrated) of the fuel cell stack 12, and the cathode electrode 34. In the cathode electrode 34, hydrogen ions and electrons react with oxygen contained in the supplied air by the action of the catalyst to generate water.

The anode system 16 has each component for supplying an anode gas to the anode electrode 32 and each component for discharging an anode off-gas from the anode electrode 32. The anode system 16 includes the anode supply flow path 40, the anode discharge flow path 42, a circulation flow path 44, a first drain flow path 46, and the second drain flow path 48. The anode system 16 includes an injector 50, an ejector 52, a gas-liquid separator 54, a first drain valve 56, and a second drain valve 58.

Note that the anode discharge flow path 42, the first drain flow path 46, and the second drain flow path 48 may be collectively referred to as an anode discharge flow path. In addition, the first drain valve 56 and the second drain valve 58 may be collectively referred to as a drain valve.

The anode supply flow path 40 communicates between the discharge port of the hydrogen tank 14 and the anode inlet 17A. The anode supply flow path 40 is provided with the injector 50, the ejector 52, and a pressure sensor 93. The ejector 52 is disposed closer to the anode inlet 17A than the injector 50. The pressure sensor 93 is disposed closer to the anode inlet 17A than the ejector 52. The pressure sensor 93 detects the pressure of an anode gas.

The anode discharge flow path 42 communicates between the first anode outlet 17B and the intake port of the gas-liquid separator 54. The circulation flow path 44 communicates between the exhaust port of the gas-liquid separator 54 and the ejector 52. The first drain flow path 46 communicates between the drain port of the gas-liquid separator 54 and the inlet of a diluent 60. The first drain flow path 46 is provided with the first drain valve 56. The second drain flow path 48 communicates between the second anode outlet 17C and the portion of the first drain flow path 46 downstream of the first drain valve 56. The second drain flow path 48 is provided with the second drain valve 58. A third drain flow path 80 communicates between the circulation flow path 44 and the inlet of the diluent 60. The third drain flow path 80 is provided with a bleed valve 82.

The cathode system 18 has each component for supplying a cathode gas to the cathode electrode 34 and each component for discharging a cathode off-gas from the cathode electrode 34. The cathode system 18 includes the cathode supply flow path 62, the cathode discharge flow path 64, and a bypass flow path 66. The cathode system 18 includes a compressor 68, a humidifier 70, a first sealing valve 74, a second sealing valve 76, and a bypass valve 78.

The cathode supply flow path 62 communicates between the intake port (not illustrated) of air and the cathode inlet 19A. The cathode supply flow path 62 is provided with the compressor 68, the first sealing valve 74, and a flow path 72A of the humidifier 70. The portion of the cathode supply flow path 62 upstream of the humidifier 70 is defined as a cathode supply flow path 62A. The portion of the cathode supply flow path 62 downstream of the humidifier 70 is defined as a cathode supply flow path 62B. A pressure sensor 95, the compressor 68, and the first sealing valve 74 are provided in the cathode supply flow path 62A. The first sealing valve 74 is disposed closer to the humidifier 70 than the compressor 68. The pressure sensor 95 is disposed closer to an air intake port (not illustrated) than the compressor 68. The pressure sensor 95 detects the pressure of the sucked air (atmosphere). The pressure sensor 95 also functions as an atmospheric pressure sensor outside the vehicle.

The cathode discharge flow path 64 communicates between the cathode outlet 19B and the inlet of the diluent 60. The cathode discharge flow path 64 is provided with a flow path 72B of the humidifier 70 and the second sealing valve 76. The portion of the cathode discharge flow path 64 upstream of the humidifier 70 is defined as a cathode discharge flow path 64A. The portion of the cathode supply flow path 62 downstream of the humidifier 70 is defined as a cathode discharge flow path 64B. The second sealing valve 76 is provided in the cathode discharge flow path 64B.

A discharge pipe 100 is constituted by, for example, a hollow pipe having a length of about 1 m. An inlet 100A of the discharge pipe 100 is connected to the outlet of the diluent 60. An outlet 100C of the discharge pipe 100 is located, for example, under the floor of a substantially central portion of the vehicle. By providing the discharge pipe 100, the gas diluted by the diluent 60 (a combined gas in which the cathode off-gas flowing through the cathode discharge flow path 64B and the anode off-gas flowing through the anode discharge flow path 42, the first drain flow path 46, the second drain flow path 48, and the third drain flow path 80 are combined) is discharged to the outside (to the atmosphere) in a space away from a user of the vehicle.

The bypass flow path 66 communicates between the cathode supply flow path 62A and the cathode discharge flow path 64B. For example, the bypass flow path 66 communicates between the portion of the cathode supply flow path 62A between the compressor 68 and the first sealing valve 74 and the portion of the cathode discharge flow path 64B downstream of the second sealing valve 76. The bypass flow path 66 is provided with the bypass valve 78.

The cooling system 20 has each component for supplying a refrigerant to the fuel cell stack 12 and each component for discharging the refrigerant from the fuel cell stack 12. The cooling system 20 includes a refrigerant supply flow path 84 and a refrigerant discharge flow path 86. In addition, the cooling system 20 includes a refrigerant pump 88, a radiator 90, and a temperature sensor 92.

A refrigerant flow path (not illustrated) for cooling the fuel cell stack 12 is formed inside the fuel cell stack 12. The refrigerant supply flow path 84 communicates between the outlet of the radiator 90 and the inlet of the refrigerant flow path. The refrigerant supply flow path 84 is provided with the refrigerant pump 88. The refrigerant discharge flow path 86 communicates between the outlet of the refrigerant flow path and the inlet of the radiator 90. The refrigerant discharge flow path 86 is provided with the temperature sensor 92. The temperature sensor 92 detects the temperature of the refrigerant discharged from the fuel cell stack 12.

The control device 94 is a computer (for example, an ECU of a vehicle). The control device 94 includes a control unit 96 and a storage unit 98. The control unit 96 includes a processing circuit. The processing circuit may be a processor such as a CPU. The processing circuit may be an integrated circuit such as an ASIC or an FPGA. The processor can execute various types of processing by executing a program stored in the storage unit 98. At least some of a plurality of types of processing may be performed by an electronic circuit including a discrete device.

The control unit 96 controls the operation of the fuel cell system 10. For example, the control unit 96 receives detection signals from various sensors provided in the fuel cell system 10. The control unit 96 outputs, based on each detection signal, a control signal for controlling each valve, the injector 50, the compressor 68, the refrigerant pump 88, or the like. Each valve, the injector 50, the compressor 68, the refrigerant pump 88, or the like operates in accordance with the control signal.

The storage unit 98 includes a volatile memory and a nonvolatile memory.

Examples of the volatile memory include a RAM and the like. The volatile memory is used as a working memory of the processor. The volatile memory temporarily stores data or the like necessary for processing or computation. Examples of the nonvolatile memory include a ROM, a flash memory, and the like. The nonvolatile memory is used as a storage memory. The nonvolatile memory stores programs, tables, maps, and the like. At least a part of the storage unit 98 may be provided in the processor, the integrated circuit, or the like as described above.

The nonvolatile memory further stores a first threshold and a second threshold. The first threshold is used to determine whether or not to perform nitrogen purge for reducing nitrogen in the anode flow path 36. The second threshold is used to determine whether or not the fuel cell stack 12 has a low load or a medium to high load. In the embodiment, the first threshold is the amount of hydrogen (hydrogen concentration) relatively estimated based on the amount of nitrogen in the anode flow path 36. The second threshold is a power generation amount of the fuel cell stack 12.

In addition, the nonvolatile memory stores information indicating an opening time tx and a closing time ty of the second drain valve 58 that periodically repeats opening and closing in a second state to be described later.

The information indicating the first threshold, the second threshold, the opening time tx, and the closing time ty is set in advance by a technician and recorded in the storage unit 98.

### <Fluid Flow>

### 1. Anode System

The flow of fluid in anode system 16 will be described.

The injector 50 injects the anode gas (hydrogen) of the hydrogen tank 14 toward the downstream side of the anode supply flow path 40. The anode gas injected from the injector 50 flows through the anode supply flow path 40 and is supplied to the anode flow path 36. The anode gas flows through the anode flow path 36 and is discharged as an anode off-gas from the first anode outlet 17B. The anode off-gas contains hydrogen that has not reacted with oxygen, nitrogen in the cathode gas that has permeated the electrolyte membrane 30, and moisture generated by the reaction between oxygen and hydrogen.

The anode off-gas flows through the anode discharge flow path 42 and is supplied to the gas-liquid separator 54. Gas-liquid separator 54 separates the anode off-gas into a gas component (anode off-gas) and a liquid component (water). The anode off-gas discharged from the gas-liquid separator 54 flows through the circulation flow path 44 and is supplied to the ejector 52. In the ejector 52, the anode off-gas combines with the anode gas injected from the injector 50.

In addition, when the bleed valve 82 of the third drain flow path 80 is opened, a part of the anode off-gas flowing through the circulation flow path 44 flows through the third drain flow path 80 and is discharged to the diluent 60. However, the bleed valve 82 is opened at the time of a low load in which a target power generation amount described later falls below the second threshold.

The water separated by the gas-liquid separator 54 is temporarily stored in the bottom of the gas-liquid separator 54. In a state where the first drain valve 56 is opened, the water stored in the gas-liquid separator 54 flows through the first drain flow path 46 and is discharged to the diluent 60. When the first drain valve 56 is opened in a state where the water in the gas-liquid separator 54 has run out, the anode off-gas of the gas-liquid separator 54 flows through the first drain flow path 46 and is discharged to the diluent 60.

In a case where the inside of the fuel cell stack 12 has high humidity, water is stored in the bottom of the anode flow path 36. In a state where the second drain valve 58 is opened, the water stored in the anode flow path 36 flows through the second drain flow path 48 and the first drain flow path 46 and is discharged to the diluent 60. When the second drain valve 58 is opened in a state where the water in the anode flow path 36 has run out, the anode off-gas in the anode flow path 36 flows through the second drain flow path 48 and the first drain flow path 46 and is discharged to the diluent 60.

### 2. Cathode System

The flow of fluid in the cathode system 18 will be described.

The compressor 68 ejects a cathode gas (air) sucked from the outside of the vehicle toward the downstream side of the cathode supply flow path 62. In a state where the first sealing valve 74 is opened, the cathode gas ejected from the compressor 68 flows through the cathode supply flow path 62 and is supplied to the cathode flow path 38. The cathode gas flows through the cathode flow path 38 and is discharged as a cathode off-gas from the cathode outlet 19B. The cathode off-gas contains each component contained in air and the moisture generated by a reaction between oxygen and hydrogen.

In a state where the second sealing valve 76 is opened, the cathode off-gas flows through the cathode discharge flow path 64 and is discharged to the diluent 60. The cathode off-gas contains moisture. In the humidifier 70, the moisture of the cathode off-gas is used to humidify the cathode gas.

In a state where the bypass valve 78 is opened, the cathode gas flows through the bypass flow path 66 and the cathode discharge flow path 64 and is discharged to the diluent 60. The bypass flow path 66 is used to decrease the amount of cathode gas supplied to the fuel cell stack 12.

### <State of Second Drain Valve and Bleed Valve>

### 1. First State

A state where any one of the second drain valve 58 and the bleed valve 82 is opened is referred to as a first state. The reason why the control unit 96 controls the second drain valve 58 and the bleed valve 82 to the first state will be described.

The control unit 96 controls the anode flow path 36 so as to suppress a decrease in the hydrogen concentration and maintain the hydrogen concentration at a certain level or more. The following (a) and (b) are considered as factors that decrease the hydrogen concentration in the anode flow path 36.
(a) The hydrogen in the anode flow path 36 is consumed by power generation of the fuel cell stack 12.
(b) The nitrogen contained in the cathode gas permeates the electrolyte membrane 30 and enters the anode flow path 36, so that the nitrogen concentration in the anode flow path 36 relatively increases.

With respect to the factor (a), the control unit 96 controls the injector 50. Accordingly, the amount of hydrogen in the anode flow path 36 increases, and the hydrogen concentration in the anode flow path 36 increases. With respect to the factor (b), the control unit 96 opens the second drain valve 58 or the bleed valve 82. Accordingly, the anode off-gas containing nitrogen is discharged from the anode flow path 36. Since hydrogen as an anode gas is appropriately supplied to the anode flow path 36, the hydrogen concentration in the anode flow path 36 relatively increases.

In the case of a medium to high load state where the target power generation amount is larger than the second threshold, it is preferable to open the second drain valve 58 rather than to open the bleed valve 82 in order to suppress a decrease in the hydrogen concentration of the anode flow path 36 (in other words, an increase in the nitrogen concentration) for the following reason.

In the embodiment, as an example, a configuration is made such that the flow rate of the nitrogen discharged through the bleed valve 82 is smaller than the flow rate of the nitrogen discharged through the second drain valve 58. In addition, a configuration is made such that the flow rate of the nitrogen discharged through the second drain valve 58 is larger than the maximum flow rate of the nitrogen permeating from the cathode flow path 38 to the anode flow path 36.

In general, when fuel cell stack 12 is heated to a high temperature during a medium to high load, the flow rate of the nitrogen permeating from the cathode flow path 38 to the anode flow path 36 increases (in other words, a nitrogen increase speed increases). Therefore, the flow rate of the nitrogen permeating from the cathode flow path 38 to the anode flow path 36 may be larger than the flow rate of the nitrogen discharged through the bleed valve 82.

In this regard, at the time of a medium to high load in which the flow rate of the nitrogen permeating from the cathode flow path 38 to the anode flow path 36 may be larger than the flow rate of the nitrogen discharged through the bleed valve 82, the second drain valve 58 is opened instead of the bleed valve 82 to discharge nitrogen so as not to fall into insufficient discharge of nitrogen. As a result, it is possible to maintain the hydrogen concentration of the fuel cell stack 12 and continue traveling of the vehicle.

The increase rate of the nitrogen in the anode flow path 36 depends on a cathode pressure, the refrigerant temperature of the cooling system 20, the humidity of the electrolyte membrane 30, or the like. These are decided based on the generated current of the fuel cell stack 12. The generated current of the fuel cell stack 12 is determined by the target power generation amount used by the control unit 96. That is, there is a correlation between the increase rate of the nitrogen in the anode flow path 36 and the target power generation amount. Therefore, the control unit 96 decides which one of the second drain valve 58 and the bleed valve 82 is opened, based on the target power generation amount. As an example, when the target power generation amount is the second threshold or more, the bleed valve 82 is closed, and the second drain valve 58 is opened, and when the target power generation amount is less than the second threshold, the bleed valve 82 is opened, and the second drain valve 58 is closed.

### 2. Second State

A state where opening and closing of the bleed valve 82 is periodically repeated is referred to as the second state. The reason why the control unit 96 controls the bleed valve 82 to the second state will be described.

The reason for diluting hydrogen in the anode off-gas in the diluent 60 described above is to prevent ignition of the hydrogen contained in the gas discharged to the outside (atmosphere).

In a case where the target power generation amount is less than the second threshold, the amount of cathode off-gas is sufficiently larger than the amount of anode off-gas. Therefore, the amount of the combined gas flowing from the diluent 60 to the discharge pipe 100 is substantially determined by the amount of cathode off-gas.

When the control unit 96 opens the bleed valve 82, the anode off-gas containing nitrogen and hydrogen combines with the cathode off-gas at the diluent 60. When combining, the hydrogen concentration of the combined gas flowing through the discharge pipe 100 increases. Here, the increase rate of the hydrogen concentration of the combined gas is slower at the outlet 100C of the discharge pipe 100 than in the vicinity of the inlet 100A of the discharge pipe 100. In this regard, in the embodiment, the control unit 96 opens the bleed valve 82 to discharge the anode off-gas from anode flow path 36, and the control unit 96 closes the bleed valve 82 before a hydrogen concentration (corresponding to a second hydrogen concentration to be described later) at the outlet 100C of the discharge pipe 100, which is increased by opening the bleed valve 82, reaches a specified value (an upper limit value at which there is no possibility of ignition).

When the hydrogen concentration at the outlet 100C decreases as the control unit 96 closes the bleed valve 82, the control unit 96 opens the bleed valve 82 again. The control unit 96 suppresses a decrease in the hydrogen concentration in the anode flow path 36 (in other words, an increase in the nitrogen concentration of the anode flow path 36) by repeating the opening/closing operation of the bleed valve 82.

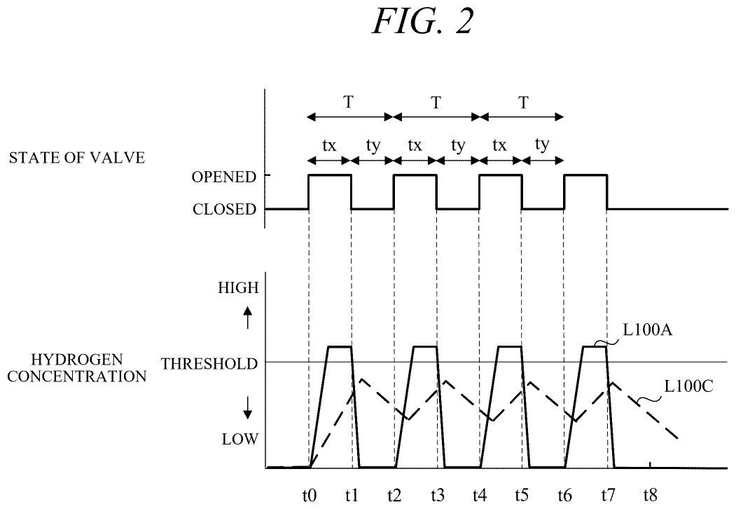

FIG. 2 is a schematic diagram illustrating a relationship between the opening/closing timing of the bleed valve 82 and the hydrogen concentration of the combined gas. A horizontal axis represents time, and a vertical axis on the upper side represents the open/close state of the bleed valve 82. In addition, a vertical axis on the lower side indicates the hydrogen concentration of the combined gas. A solid line L100A indicates the hydrogen concentration at the inlet 100A of the discharge pipe 100, and a broken line L100C indicates the hydrogen concentration (second hydrogen concentration) at the outlet 100C of the discharge pipe 100. A threshold on the vertical axis on the lower side corresponds to the above specified value.

When the bleed valve 82 is opened at time to, the hydrogen concentration (second hydrogen concentration) at the outlet 100C of the discharge pipe 100 increases at a speed slower than the increase rate of the hydrogen concentration at the inlet 100A of the discharge pipe 100. When the bleed valve 82 is closed at time t1, the hydrogen concentration (second hydrogen concentration) at the outlet 100C of the discharge pipe 100 decreases at a rate slower than the decrease rate of the hydrogen concentration at the inlet 100A of the discharge pipe 100. Note that the decrease rate is faster than the increase rate. Therefore, the closing time ty of the bleed valve 82 may be shorter than the opening time tx. Thereafter, similarly, the bleed valve 82 repeats opening and closing at the cycle T.

In the second state, while the bleed valve 82 repeats opening and closing, the control unit 96 controls the opening/closing timing of the bleed valve 82 such that the hydrogen concentration (second hydrogen concentration) at the outlet 100C of the discharge pipe 100 does not reach the threshold (specified value). Therefore, it is not necessary to increase dilution air to be sent to the diluent 60, so that the power consumption of the compressor 68 is suppressed.

The opening time tx of the bleed valve 82 that repeats opening and closing in the second state is decided for each hydrogen concentration in consideration of the flow velocity of the combined gas at the outlet 100C of the discharge pipe 100 by, for example, a technician, and is recorded in the storage unit 98 in advance. More specifically, the flow velocity at the outlet 100C of the discharge pipe 100 is obtained from the information indicating the shape of the discharge pipe 100 and the amount of the combined gas flowing through the discharge pipe 100. The amount of the combined gas is calculated, for example, by subtracting the amount of the oxygen consumed by power generation from the amount of the cathode gas supplied to the cathode supply flow path 62. As an example, a technician performs an ignition test at the outlet 100C of the discharge pipe 100 while changing the condition of the combination of the hydrogen concentration and the flow velocity of the combined gas, and decides the opening time tx of the bleed valve 82 and the closing time ty shorter than the opening time tx for each hydrogen concentration (second hydrogen concentration), based on the test result. Then, the opening time tx and the closing time ty corresponding to the hydrogen concentration (second hydrogen concentration) are recorded in the storage unit 98 so that the control unit 96 can read the opening time tx and the closing time ty while the fuel cell system 10 is in operation.

Note that in a case where the control unit 96 calculates necessary opening time tx and closing time ty in real time by using the hydrogen concentration (second hydrogen concentration), the information indicating the shape of discharge pipe 100, and the amount of the cathode gas supplied to the cathode supply flow path 62 during the operation of the fuel cell system 10, it is sufficient that the information indicating the shape of discharge pipe 100, an arithmetic expression for deriving the opening time tx and the closing time ty, or the like is recorded in storage unit 98 in advance.

### 3. Third State

A state where the second drain valve 58 and the bleed valve 82 are closed is referred to as a third state. The reason why the control unit 96 controls the second drain valve 58 and the bleed valve 82 to the third state will be described.

As described above, the control unit 96 controls the anode flow path 36 so as to suppress a decrease in the hydrogen concentration (first hydrogen concentration) and maintain the hydrogen concentration (first hydrogen concentration) at a certain level or more. In a case where the hydrogen concentration (first hydrogen concentration) of the anode flow path 36 is not lowered, there is no reason to set the second drain valve 58 and the bleed valve 82 to the above first state and the above second state in order to discharge the anode off-gas containing nitrogen from the anode flow path 36 (nitrogen purge). Therefore, the control unit 96 closes the second drain valve 58 and the bleed valve 82 (that is, set to the third state). Accordingly, the anode off-gas flows through the anode discharge flow path 42, the gas-liquid separator 54, the circulation flow path 44, and the ejector 52 in this order, and is returned to the anode supply flow path 40.

### <Description of Flowchart>

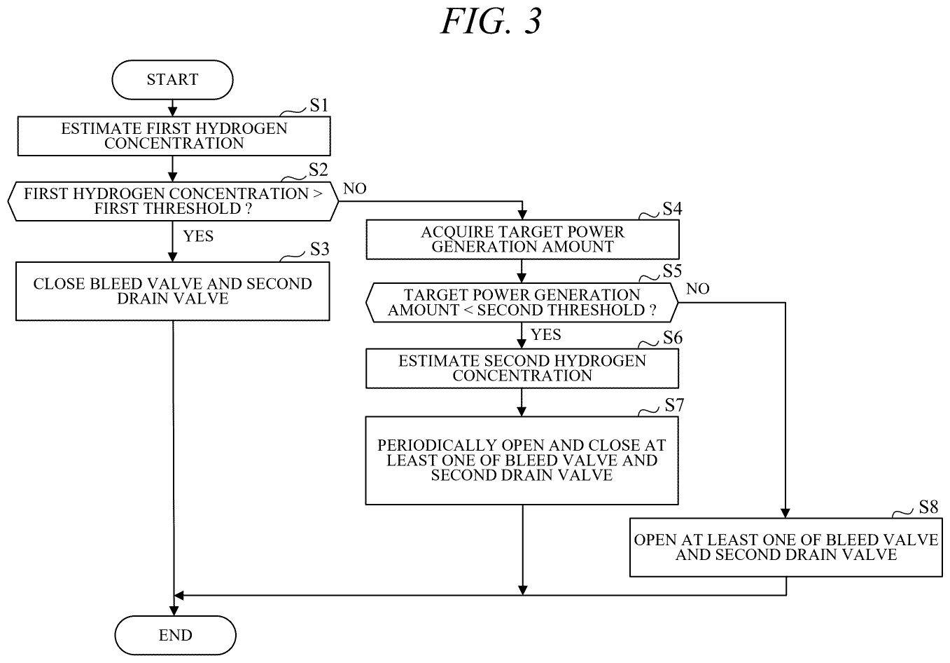

FIG. 3 is a flowchart illustrating an example of valve control processing executed by the control unit 96 based on a predetermined program. The control unit 96 repeats the valve control processing illustrated in FIG. 2 during the operation of the fuel cell system 10.

In S1 (S: processing step), the control unit 96 estimates the first hydrogen concentration. More specifically, the control unit 96 estimates the amount of nitrogen in the anode flow path 36. The amount of nitrogen having permeated from the cathode flow path 38 to the anode flow path 36 (the amount of permeated nitrogen) can be calculated by multiplying a nitrogen partial pressure difference between the anode flow path 36 and the cathode flow path 38 by a nitrogen permeation coefficient. There is a correlation between the internal temperature of the fuel cell stack 12 and the nitrogen permeation coefficient. In addition, there is a correlation between the internal humidity of the fuel cell stack 12 and the nitrogen permeation coefficient. For example, the control unit 96 controls each component of the fuel cell system 10 such that the internal humidity of the fuel cell stack 12 becomes 100%. In this case, the nitrogen permeation coefficient can be estimated based on the internal temperature of the fuel cell stack 12. In the embodiment, the control unit 96 calculates the internal temperature of the fuel cell stack 12 based on the temperature of the refrigerant detected by the temperature sensor 92. Further, the control unit 96 estimates the amount of nitrogen in the anode flow path 36 based on the internal temperature of the fuel cell stack 12. The control unit 96 relatively estimates the hydrogen amount (first hydrogen concentration) based on the estimated nitrogen amount. Various estimation methods are stored in the storage unit 98.

Note that the internal temperature of the fuel cell stack 12 can also be calculated from the temperature of the cathode off-gas flowing through the cathode discharge flow path 64 or the temperature of the anode off-gas flowing through the anode discharge flow path 42. In addition, the internal temperature of the fuel cell stack 12 can also be directly detected by a temperature sensor or the like. When S1 ends, the control unit 96 proceeds to S2.

In S2, the control unit 96 determines whether or not first hydrogen concentration>first threshold is satisfied. If the first hydrogen concentration relatively estimated from the nitrogen amount estimated in S1 exceeds the first threshold, the control unit 96 makes an affirmative determination in S2 and proceeds to S3. If the first hydrogen concentration is equal to or less than the first threshold, the control unit 96 makes a negative determination in S2 and proceeds to S4. Note that in a case where the first hydrogen concentration is equal to the second threshold, the process may proceed to S4.

The process proceeds to S3 in a case where there is no reason to discharge nitrogen from the anode flow path 36. In S3, the control unit 96 controls both the bleed valve 82 and the second drain valve 58 to be in the third state of closing, and ends the processing according to FIG. 3. In a case where the bleed valve 82 is already closed, the control unit 96 maintains the state of the bleed valve 82. On the other hand, in a case where the bleed valve 82 is opened, the control unit 96 closes the bleed valve 82. In a case where the second drain valve 58 is already closed, the control unit 96 maintains the state of the second drain valve 58. On the other hand, in a case where the second drain valve 58 is opened, the control unit 96 closes the second drain valve 58. The anode off-gas flows through the anode discharge flow path 42, the gas-liquid separator 54, the circulation flow path 44, and the ejector 52 in this order, and is returned to the anode supply flow path 40.

In S4, the control unit 96 acquires a target power generation amount. As described above, the target power generation amount is a determination factor for determining whether the fuel cell stack 12 has a low load or a medium to high load. During the operation of the fuel cell system 10, the control unit 96 calculates the target power generation amount, and controls each component such that the power generation amount of the fuel cell stack 12 becomes the target power generation amount. The control unit 96 uses the target power generation amount calculated to control the power generation amount of the fuel cell stack 12. When S4 ends, the control unit 96 proceeds to S5.

In S5, the control unit 96 determines whether or not target power generation amount<second threshold is satisfied. If the target power generation amount is less than the second threshold (low load), the control unit 96 makes an affirmative determination in S3 and proceeds to S6. If the target power generation amount is the second threshold or more (medium to high load), the control unit 96 makes a negative determination in S5 and proceeds to S8. Note that in a case where the target power generation amount is equal to the second threshold, the process may proceed to S8.

In S6, the control unit 96 estimates the second hydrogen concentration. More specifically, the amount of hydrogen in the combined gas flowing from the diluent 60 to the discharge pipe 100 is the sum of the amount of the hydrogen discharged from the first drain flow path 46, the second drain flow path 48, and the third drain flow path 80 and the amount of the hydrogen having permeated from the anode flow path 36 to the cathode flow path 38 (permeated hydrogen amount).

The amount of the hydrogen discharged from the first drain flow path 46, the second drain flow path 48, and the third drain flow path 80 can be calculated from the pressure of the anode gas (the value detected by the pressure sensor 93), the atmospheric pressure (the value detected by the pressure sensor 95), the gas density of the anode flow path 36, or the like. The gas density of anode flow path 36 can be calculated based on the pressure of the anode gas, the internal temperature of the fuel cell stack 12 (calculated based on the value detected by the temperature sensor 92), and an average molecular weight. The average molecular weight is calculated from the pressure of the anode gas and a hydrogen partial pressure. The hydrogen partial pressure is calculated on the assumption that only water vapor and hydrogen are present, for example.

In addition, the amount of permeated hydrogen can be calculated based on the pressure of the anode gas and the hydrogen permeation characteristics of the inside of the fuel cell stack 12 (which can be estimated based on the internal temperature of the fuel cell stack 12). When S6 ends, the control unit 96 proceeds to S7.

In S7, the control unit 96 periodically controls opening and closing of at least one (here, the bleed valve 82 exemplified as the second state) of the bleed valve 82 or the second drain valve 58, and ends the processing according to FIG. 3. A part of the anode off-gas flows through the third drain flow path 80 and is directly discharged to the diluent 60.

Note that the control unit 96 reads, from the storage unit 98, information indicating the opening time tx and the closing time ty corresponding to the second hydrogen concentration estimated in S6 and controls opening and closing of the second drain valve 58.

In S8 to which the processing proceeds after the negative determination in S5, the control unit 96 performs control to the third state where at least one of the bleed valve 82 or the second drain valve 58 is opened. For example, the bleed valve 82 is closed, the second drain valve 58 is opened, and the processing according to FIG. 3 ends. In a case where the bleed valve 82 is already closed, the control unit 96 maintains the state of the bleed valve 82. On the other hand, in a case where the bleed valve 82 is opened, the control unit 96 closes the bleed valve 82. In a case where the second drain valve 58 is already opened, the control unit 96 maintains the state of the second drain valve 58. On the other hand, in a case where the second drain valve 58 is closed, the control unit 96 opens the second drain valve 58. A part of the anode off-gas flows through the second drain flow path 48 and is directly discharged to the diluent 60.

According to the embodiment described above, the following effects are obtained.

(1) The fuel cell system 10 includes: the fuel cell stack 12 that generates power by an anode gas in the anode flow path 36 and a cathode gas in the cathode flow path 38; the anode supply flow path 40 that supplies an anode gas to the anode flow path 36; the cathode supply flow path 62 that supplies a cathode gas to the cathode flow path 38; the anode discharge flow path (anode discharge flow path 42, first drain flow path 46, second drain flow path 48, third drain flow path 80) through which an anode off-gas as an anode discharge fluid discharged from the anode flow path 36 flows; the cathode discharge flow path 64 (64A, 64B) through which a cathode off-gas as a cathode discharge fluid discharged from the cathode flow path 38 flows; the diluent 60 as a fluid combining portion that combines the anode off-gas flowing through the anode discharge flow path (anode discharge flow path 42, first drain flow path 46, second drain flow path 48, third drain flow path 80) and the cathode off-gas flowing through the cathode discharge flow path 64 (64A, 64B); the discharge pipe 100 that guides a combined gas as the combined fluid combined by diluent 60 to the outside; the bleed valve 82, the second drain valve 58, and the first drain valve 56 as anode discharge valves that control a flow of the anode off-gas toward the diluent 60; and the control unit 96 that controls opening and closing of the anode discharge valve (the bleed valve 82, the second drain valve 58, the first drain valve 56). The control unit 96 acquires the second hydrogen concentration as the hydrogen concentration of the combined gas, and in a case where the power generation amount of the fuel cell stack 12 is equal to or less than a second threshold as a predetermined power generation threshold, controls opening and closing of the anode discharge valve (as an example, the bleed valve 82) so as to repeat an opening/closing operation of opening for a predetermined opening time tx based on the second hydrogen concentration and closing.

With such a configuration, for example, in a case where the fuel cell stack 12 has a low load, by repeating opening and closing of the bleed valve 82 for the opening and closing time based on the second hydrogen concentration of the combined gas, it is possible to suppress the second hydrogen concentration of the combined gas to be equal to or less than a specified value without increasing a dilution air.

(2) In the fuel cell system 10 of (1), the control unit 96 further acquires a first hydrogen concentration as the hydrogen concentration of the anode off-gas, and in a case where the first hydrogen concentration is equal to or less than a first threshold as a predetermined concentration threshold and the power generation amount of the fuel cell stack 12 is equal to or less than a second threshold, the control unit 96 controls opening and closing of the anode discharge valve (as an example, bleed valve 82) so as to repeat an opening/closing operation of opening for an opening time based on the second hydrogen concentration of the combined gas and closing for a closing time shorter than the opening time.

With such a configuration, in a case where the hydrogen concentration of the anode off-gas decreases and the fuel cell stack 12 has a low load, by opening or closing the bleed valve 82 based on the second hydrogen concentration of the combined gas, it is possible to suppress the second hydrogen concentration of the combined gas to be equal to or less than the specified value without increasing a dilution air.

(3) In the fuel cell system 10 of (1), the control unit 96 further acquires the first hydrogen concentration as the hydrogen concentration of the anode off-gas, and opens the anode discharge valve (second drain valve 58) in a case where the hydrogen concentration of the anode off-gas is equal to or less than a first threshold as a predetermined concentration threshold and the power generation amount of the fuel cell stack 12 exceeds a second threshold.

With this configuration, in a case where the hydrogen concentration of the anode off-gas decreases and the fuel cell stack 12 has a medium to high load, nitrogen purge is performed by opening the second drain valve 58, so that a decrease in the hydrogen concentration of the anode flow path 36 can be suppressed.

(4) In the fuel cell system 10 of (1) to (3), the control unit 96 acquires the hydrogen concentration at the outlet 100C of the discharge pipe 100 as the hydrogen concentration (second hydrogen concentration) of the combined gas, further acquires the flow velocity of the combined gas at the outlet 100C of the discharge pipe 100, and decides the opening time tx of the bleed valve 82 based on the flow velocity and the second hydrogen concentration at the outlet 100C.

With this configuration, in a case where the fuel cell stack 12 has a low load, appropriate opening time tx can be decided for each combination of the second hydrogen concentration and the flow velocity at the outlet 100C of the discharge pipe 100. Accordingly, the bleed valve 82 can be opened and closed so as to repeat the opening/closing operation of opening and closing for the opening time tx. As a result, it is possible to suppress the hydrogen concentration (second hydrogen concentration) of the combined gas to the specified value or less without increasing a dilution air.

(5) In the fuel cell system 10 of (1) to (3), the control unit 96 acquires the second hydrogen concentration as the hydrogen concentration of the combined gas at the outlet 100C of the discharge pipe 100, and decides the opening time tx of the bleed valve 82 based on the shape of the discharge pipe 100 and the second hydrogen concentration at the outlet 100C.

With this configuration, it is possible to decide an appropriate opening time tx in consideration of the shape of the discharge pipe 100 (in other words, the flow velocity at the outlet 100C estimated based on the shape is reflected) for each second hydrogen concentration of the combined gas at the outlet 100C of the discharge pipe 100. Accordingly, the bleed valve 82 can be opened and closed so as to repeat the opening/closing operation of opening and closing for the opening time tx. As a result, it is possible to suppress the hydrogen concentration (second hydrogen concentration) of the combined gas to the specified value or less without increasing a dilution air.

(6) In the fuel cell system 10 of (1) to (3), the control unit 96 acquires the second hydrogen concentration as the hydrogen concentration of the combined gas at the outlet 100C of the discharge pipe 100, and decides, as the opening time tx, a time shorter than a time until the second hydrogen concentration at the outlet 100C rises to a predetermined specified value after the bleed valve 82 is opened.

With this configuration, it is possible to decide the opening time tx shorter than the time until the second hydrogen concentration at the outlet 100C of the discharge pipe 100 rises to, for example, a specified value corresponding to the concentration at which ignition occurs after the bleed valve 82 is opened. Accordingly, the bleed valve 82 can be opened and closed so as to repeat the opening/closing operation of opening and closing for the opening time tx. As a result, it is possible to suppress the hydrogen concentration (second hydrogen concentration) of the combined gas to the specified value or less without increasing a dilution air.

The above embodiments can be modified in various manners. Hereinafter, modifications will be described.

### (First Modification)

In the above embodiment, an example has been described in which only the bleed valve 82 among the first drain valve 56, the second drain valve 58, and the bleed valve 82 is periodically controlled to be opened and closed in the second state. Alternatively, in the second state, not only the bleed valve 82 but also at least one valve of the first drain valve 56, the second drain valve 58, or the bleed valve 82 may be periodically controlled to be opened or closed. In the case of the second state, an appropriate opening time tx and an appropriate closing time ty may be determined depending on which valve is to be subjected to the periodic opening/closing control.

In addition, an example has been described in which only the second drain valve 58 among the first drain valve 56, the second drain valve 58, and the bleed valve 82 is opened in the first state. Alternatively, not only the second drain valve 58 but also at least one valve of the first drain valve 56, the second drain valve 58, or the bleed valve 82 may be opened in the first state.

### (Second Modification)

In the above embodiment, the fuel cell system 10 is exemplified which includes the first drain flow path 46, the second drain flow path 48, and the third drain flow path 80 as the anode discharge flow paths, and the first drain valve 56, the second drain valve 58, and the bleed valve 82 as the anode discharge valves that control the flow of the anode off-gas flowing through the anode discharge flow paths. However, the present invention may also be applied to a fuel cell system including a connection flow path that connects the anode discharge flow path to a cathode supply flow path and an on-off valve that opens and closes the connection flow path.

In addition, the present invention may also be applied to a fuel cell system that does not include any one of the first drain valve 56 or the second drain valve 58 in the above embodiment.

The above embodiment can be combined as desired with one or more of the aforesaid modifications. The modifications can also be combined with one another.

According to the present invention, it becomes possible to make it unnecessary to increase the amount of air for diluting the gas to be discharged in a case where the power generation amount is smaller than a predetermined threshold. Suppressing an increase in the amount of air contributes to improvement in energy efficiency.

Above, while the present invention has been described with reference to the preferred embodiments thereof, it will be understood, by those skilled in the art, that various changes and modifications may be made thereto without departing from the scope of the appended claims.

1. A fuel cell system, comprising:
a fuel cell stack configured to generate power by anode gas in an anode flow path and cathode gas in a cathode flow path:
an anode supply flow path supplying the anode gas to the anode flow path;
a cathode supply flow path supplying the cathode gas to the cathode flow path;
an anode discharge flow path discharging anode off-gas from the anode flow path;
a cathode discharge flow path discharging cathode off-gas from the cathode flow path;
a combining portion combining the anode off-gas flowing through the anode discharge flow path and the cathode off-gas flowing through the cathode discharge flow path;
a discharge pipe guiding combined gas combined in the combining portion to outside;
an anode discharge valve configured to control flow of the anode off-gas toward the combining portion; and
a control unit configured to control opening and closing of the anode discharge valve, wherein
the control unit:
acquires a hydrogen concentration of the combined gas; and
controls opening and closing of the anode discharge valve to repeat an opening/closing operation of opening for an opening time based on the hydrogen concentration and closing in a case where a power generation amount of the fuel cell stack is equal to or less than a power generation threshold.

2. The fuel cell system according to claim 1, wherein
the control unit:
further acquires a hydrogen concentration of the anode off-gas; and
controls opening and closing of the anode discharge valve to repeat the opening/closing operation of opening for the opening time based on the hydrogen concentration of the combined gas and closing for a closing time shorter than the opening time in a case where the hydrogen concentration of the anode off-gas is equal to or less than a concentration threshold and the power generation amount of the fuel cell stack is equal to or less than the power generation threshold.

3. The fuel cell system according to claim 1, wherein
the control unit:
further acquires a hydrogen concentration of the anode off-gas; and
opens the anode discharge valve in a case where the hydrogen concentration of the anode off-gas is equal to or less than a concentration threshold and the power generation amount of the fuel cell stack exceeds the power generation threshold.

4. The fuel cell system according to claim 1, wherein
the control unit:
acquires a hydrogen concentration at an outlet of the discharge pipe as the hydrogen concentration of the combined gas;
further acquires a flow velocity of the combined gas at the outlet of the discharge pipe; and
determines the opening time of the anode discharge valve based on the flow velocity and the hydrogen concentration at the outlet.

5. The fuel cell system according to claim 1, wherein
the control unit:
acquires the hydrogen concentration of the combined gas at an outlet of the discharge pipe; and
determines the opening time of the anode discharge valve based on a shape of the discharge pipe and the hydrogen concentration at the outlet.

6. The fuel cell system according to claim 1, wherein
the control unit:
acquires the hydrogen concentration of the combined gas at an outlet of the discharge pipe; and
determines a time shorter than a time until the hydrogen concentration at the outlet rises to a specified value after the anode discharge valve is opened as the opening time.

7. The fuel cell system according to claim 1, wherein
the control unit acquires the hydrogen concentration of the combined gas based on amount of hydrogen in the anode off-gas flowing through the anode discharge flow path and amount of the hydrogen permeated from the anode flow path to the cathode flow path.
